(19) United States
(12) Patent Application Publication
(10) Pub. No.: US 2023/0131879 A1
(43) Pub. Date: Apr. 27, 2023

(54) WIRELESS POWER TRANSMISSION CONDITION LEARNING APPARATUS, WIRELESS POWER TRANSMISSION CONDITION DETERMINING APPARATUS, WIRELESS POWER TRANSMISSION APPARATUS, AND WIRELESS POWER RECEIVING APPARATUS

(71) Applicant: Mitsubishi Electric Corporation, Tokyo (JP)

(72) Inventors: Yukihiro HOMMA, Chiyoda-ku, Tokyo (JP); Kensuke BABA, Chiyoda-ku, Tokyo (JP)

(73) Assignee: Mitsubishi Electric Corporation, Tokyo (JP)

(21) Appl. No.: 17/911,662

(22) PCT Filed: Mar. 26, 2021
(86) PCT No.: PCT/JP2021/012970

§ 371 Date: Sep. 15, 2022

(30) Foreign Application Priority Data
Mar. 30, 2020 (JP) 2020-060273

(51) Int. Cl. H02J 50/23; H02J 50/90

(52) U.S. Cl. CPC H02J 50/23; H02J 50/90

(57) ABSTRACT

The present apparatus receives input of any two or more of input information items of distance information on a distance between a power transmission device and a power receiving device, environment information on an environment of a power transmission space between power transmission device and power receiving device, or condition information that is at least one of a device performance condition or a device setting condition of power transmission device and power receiving device, receives input of beam pattern information on a power transmission beam pattern formed by power transmission device and a power transmission efficiency of power transmission beam pattern for each combined condition of any two or more of the input information items inputted through a device information inputter, and learns power transmission beam pattern which has the power transmission efficiency that is within a predetermined range for the each combined condition from the beam pattern information.

### TECHNICAL FIELD

The present disclosure relates to a wireless power transmission condition learning apparatus that learns a power transmission beam pattern formed for transmitting an electromagnetic wave from a power transmission device to a power receiving device, a wireless power transmission condition determining apparatus using the wireless power transmission condition learning device, a wireless power transmission apparatus, and a wireless power receiving apparatus.

### BACKGROUND ART

Conventionally, a wireless power transmission apparatus and a wireless power receiving apparatus (wireless power transmission system) that transmit an electromagnetic wave from a power transmission device to a power receiving device use a retrodirective system (see, for example, PTL 1). In the retrodirective system, a transmission antenna of the power transmission device includes a plurality of antenna elements. From a pilot signal transmitted from an installation point of a reception antenna of the power receiving device, an arrival angle of the pilot signal is detected by an amplitude monopulse system. Then, a main beam of the transmission antenna formed by the plurality of antenna elements based on the angle of arrival is directed toward the reception antenna by controlling a phase of the electromagnetic wave.

On the other hand, there is a conventional wireless power transmission system that uses a rotating element electric field vector method (REV method) so as to maximize the power reception intensity by controlling the phase of the electromagnetic wave (see, for example, PTL 2). As described in Japanese Patent Laid-Open No. 2001-201526, in the REV method (rotating element electric field vector method), a radio field intensity and a phase of a composite wave by the plurality of antenna elements of the power transmission device are measured, and on the basis of these measurement results, highly accurate phase adjustment can be performed in consideration of a correction of an amplitude error and a phase error according to a phase rotation on a path including a phase shifter.

Furthermore, there is a conventional wireless power transmission system that transmits an electromagnetic wave while switching between two or more power transmission beam patterns under a condition including a power transmission period of each of two or more power transmission beam patterns among a plurality of different ZU power transmission beam patterns (see, for example, PTL 3). There is also a conventional wireless power transmission system that adjusts a power level when an object such as a living organism identified from an image is present (see, for example, PTL 4).

PTL 4 discloses a use of computer vision software programmed to find and recognize an object from an image. It is also disclosed that the computer vision software can execute various algorithms that enable the software to learn intelligently identification information of various physical objects on the basis of specific characteristics of the objects, such as shape, orientation, movement, dimensions, radiation of RF radiation, light, and heat radiation. Therefore, regarding computer vision software, use of a learning model by machine learning using artificial intelligence (AI) or the like is suggested.

### CITATION LIST

### Patent Literature

PTL 1: Japanese Patent Laid-Open No. 2005-328650

PTL 2: Japanese Patent Laid-Open No. 2011-142708

PTL 3: Japanese Patent Laid-Open No. 2019-140900

PTL 4: National Patent Publication No. 2019-506826

### SUMMARY OF INVENTION

### Technical Problem

However, in the conventional wireless power transmission system, there is a problem that learning (machine learning) of a power transmission beam pattern formed for power transmission and use of a learning result (learning model) are not considered. PTL 4 merely discloses that the computer vision software can learn intelligently the identification information of various physical objects on the basis of specific characteristics of objects of radiation of RF radiation.

The present disclosure has been made to solve the above problem, and it is an object of the present disclosure to obtain a wireless power transmission condition learning apparatus that learns a power transmission beam pattern formed for transmitting an electromagnetic wave from a power transmission device to a power receiving device, a wireless power transmission condition determining apparatus using the wireless power transmission condition learning device, a wireless power transmission apparatus, and a wireless power receiving apparatus.

### Solution to Problem

A wireless power transmission condition learning apparatus of the present disclosure to learn a power transmission beam pattern formed to transmit an electromagnetic wave from a power transmission device to a power receiving device includes a device information inputter to receive input of any two or more of input information items of distance information that is information on a distance between the power transmission device and the power receiving device, environment information that is information on an environment of a power transmission space between the power transmission device and the power receiving device, or condition information that is at least one of a device performance condition or a device setting condition of the power transmission device and the power receiving device, a beam pattern information inputter to receive input of beam pattern information that is information on the power transmission beam pattern formed by the power transmission device and a power transmission efficiency of the power transmission beam pattern for each combined condition of any two or more of the input information items inputted through the device information inputter, and a learner to learn the power transmission beam pattern having the power transmission efficiency being within a predetermined range for the each combined condition from the beam pattern information.

A wireless power transmission condition determining apparatus of the present disclosure uses a teaming result of the wireless power transmission condition learning apparatus to learn a power transmission beam pattern formed to transmit an electromagnetic wave from a power transmission device to a power receiving device, the wireless power transmission condition learning apparatus including a device information inputter to receive input of any two or more of input information items of distance information that is information on a distance between the power transmission device and the power receiving device, environment information that is information on an environment of a power transmission space between the power transmission device and the power receiving device, or condition information that is at least one of a device performance condition or a device setting condition of the power transmission device and the power receiving device, a beam pattern information inputter to receive input of beam pattern information that is information on the power transmission beam pattern formed by the power transmission device and a power transmission efficiency of the power transmission beam pattern for each combined condition of any two or more of the input information items inputted through the device information inputter, and a learner to learn the power transmission beam pattern having the power transmission efficiency being within a predetermined range for the each combined condition from the beam pattern information. The wireless power transmission condition determining apparatus includes an input information inputter to receive input of a new input information item of the input information items, and a wireless power transmission condition determiner to determine the power transmission beam pattern having the power transmission efficiency being within a predetermined range using the new input information item inputted through the input information inputter based on a learning result learned by the learner.

A wireless power transmission apparatus of the present disclosure transmits power in the power transmission beam pattern determined by the wireless power transmission condition determining apparatus using a learning result of the wireless power transmission condition learning apparatus to learn a power transmission beam pattern formed to transmit an electromagnetic wave from a power transmission device to a power receiving device, the wireless power transmission condition learning apparatus including a device information inputter to receive input of arty two or more of input information items of distance information that is information on a distance between the power transmission device and the power receiving device, environment information that is information on an environment of a power transmission space between the power transmission device and the power receiving device, or condition information that is at least one of a device performance condition or a device setting condition of the power transmission device and the power receiving device, a beam pattern information inputter to receive input of beam pattern information that is information on the power transmission beam pattern formed by the power transmission device and a power transmission efficiency of the power transmission beam pattern for each combined condition of any two or more of the input information items inputted through the device information inputter, and a learner to learn the power transmission beam pattern having the power transmission efficiency being within a predetermined range for the each combined condition from the beam pattern information. The wireless power transmission condition determining apparatus includes an input information inputter to receive input of a new input information item of the input information items, and a wireless power transmission condition determiner to determine the power transmission beam pattern having the power transmission efficiency being within a predetermined range using the new input information item inputted through the input information inputter based on a learning result learned by the learner. The wireless power transmission apparatus includes a beam controller to generate information on a phase and an amplitude of an electromagnetic wave that forms the power transmission beam pattern for transmitting power, and a power transmitter to form the power transmission beam pattern from the information on the phase and the amplitude of the electromagnetic wave generated by the beam controller.

A wireless power receiving apparatus of the present disclosure receives power transmitted in the power transmission beam pattern formed by the wireless power transmission apparatus that transmits power in the power transmission beam pattern determined by the wireless power transmission condition determining apparatus using a learning result of the wireless power transmission condition learning apparatus to learn a power transmission beam pattern formed to transmit an electromagnetic wave from a power transmission device to a power receiving device, the wireless power transmission condition learning apparatus including a device information inputter to receive input of any two or more of input information items of distance information that is information on a distance between the power transmission device and the power receiving device, environment information that is information on an environment of a power transmission space between the power transmission device and the power receiving device, or condition information that is at least one of a device performance condition or a device setting condition of the power transmission device and the power receiving device, a beam pattern information inputter to receive input of beam pattern information that is information on the power transmission beam pattern formed by the power transmission device and a power transmission efficiency of the power transmission beam pattern for each combined condition of any two or more of the input information items inputted through the device information inputter, and a learner to learn the power transmission beam pattern having the power transmission efficiency being within a predetermined range for the each combined condition from the beam pattern information. The wireless power transmission condition determining apparatus includes an input information inputter to receive input of a new input information item of the input information items, and a wireless power transmission condition determiner to determine the power transmission beam pattern having the power transmission efficiency being within a predetermined range using the new input information item inputted through the input information inputter based on a learning result learned by the learner. The wireless power transmission apparatus includes a beam controller to generate information on a phase and an amplitude of an electromagnetic wave that forms the power transmission beam pattern for transmitting power, and a power transmitter to form the power transmission beam pattern from the information on the phase and the amplitude of the electromagnetic wave generated by the beam controller. The wireless power receiving apparatus includes a power receiver to receive the power in the power transmission beam pattern, and a rectifier to rectify the power received by the power receiver.

### Advantageous Effects of Invention

The present disclosure makes it possible to obtain a wireless power transmission condition learning apparatus capable of learning a power transmission beam pattern having power transmission efficiency being within a predetermined range, a wireless power transmission condition determining apparatus using the wireless power transmission condition learning apparatus, a wireless power transmission apparatus, and a wireless power receiving apparatus.

### BRIEF DESCRIPTION OF DRAWINGS

FIG. 1 is a configuration diagram of a wireless power transmission apparatus and a wireless power receiving apparatus (wireless power transmission system) according to a first embodiment.

FIG. 2 is a functional block diagram of the wireless power transmission apparatus and the wireless power receiving apparatus (wireless power transmission system) according to the first embodiment.

FIG. 3 is a functional block diagram of a wireless power transmission condition learning apparatus according to the first embodiment.

FIG. 4 is a flowchart illustrating an operation of the wireless power transmission condition learning apparatus (wireless power transmission condition learning method) according to the first embodiment.

FIG. 5 is a functional block diagram of the wireless power transmission condition learning apparatus and a wireless power transmission condition determining apparatus according to the first embodiment.

FIG. 6 is a flowchart illustrating an operation of the wireless power transmission condition determining apparatus (wireless power transmission condition determining method) according to the first embodiment.

FIG. 7 is a functional block diagram of the wireless power transmission condition learning apparatus, the wireless power transmission condition determining apparatus, the wireless power transmission apparatus, and the wireless power receiving apparatus according to the first embodiment.

FIG. 8 is a functional block diagram of the wireless power transmission condition learning apparatus, the wireless power transmission condition determining apparatus, the wireless power transmission apparatus, and the wireless power receiving apparatus according to the first embodiment.

### DESCRIPTION OF EMBODIMENTS

### First Embodiment

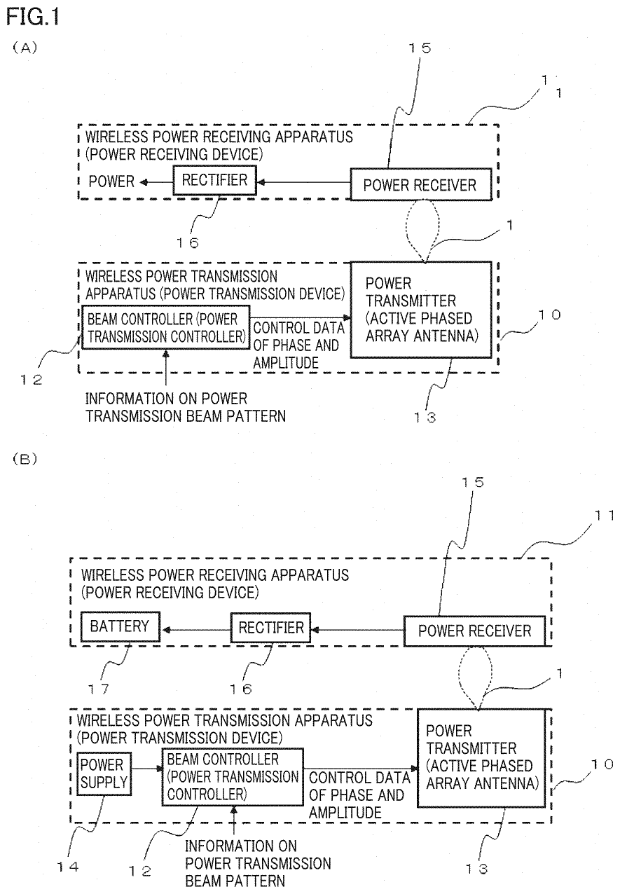

Hereinafter, a wireless power transmission condition learning apparatus, a wireless power transmission condition determining apparatus using the wireless power transmission condition learning apparatus, a wireless power transmission apparatus, and a wireless power receiving apparatus, according to a first embodiment is described with reference to FIGS. 1 to 8. In the drawings, the same reference signs denote the same or corresponding parts, and detailed description thereof is not repeated. FIG. 1(A) is a functional block diagram of a wireless power transmission apparatus 10 (power transmission device 10) and a wireless power receiving apparatus 11 (power receiving device 11) constituting a wireless power transmission system using a power transmission beam pattern 1. The wireless power transmission system transmits power from wireless power transmission apparatus 10 to wireless power receiving apparatus 11 by an electromagnetic wave.

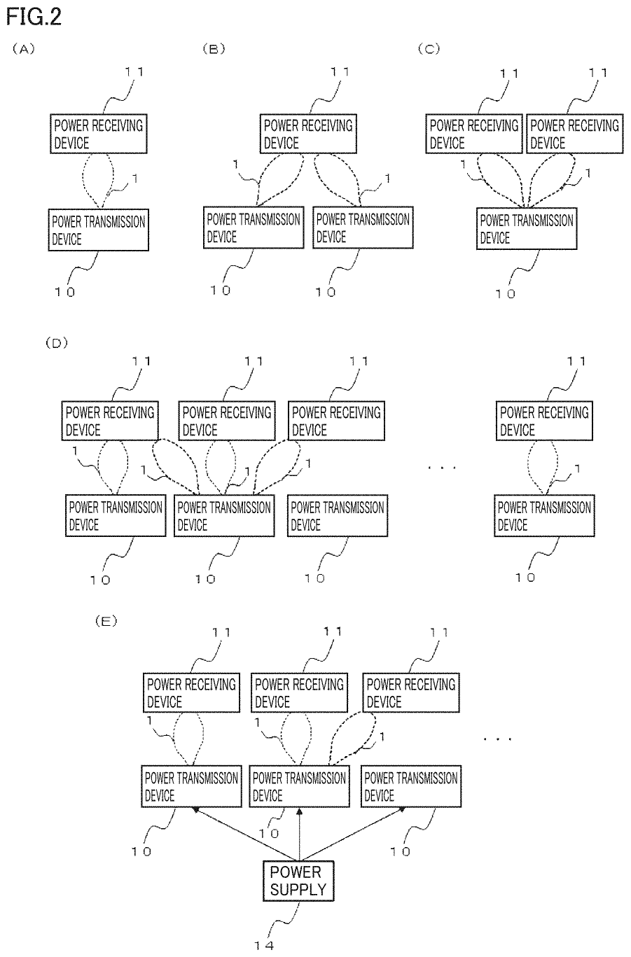

In FIG. 1(A), wireless power transmission apparatus 10 receives information on power transmission beam pattern 1 from outside, and a beam controller (power transmission controller) 12 included in wireless power transmission apparatus 10 controls a power transmitter 13 which is an active phased array antenna 13 (power transmission antenna 13) included in wireless power transmission apparatus 10 to form power transmission beam pattern 1. Beam controller 12 (power transmission controller 12) sends control data of a phase and an amplitude based on the information of the power transmission beam pattern to power transmitter 13 for control. Wireless power receiving apparat 11 includes a power receiver 15 (power receiving antenna 15) that receives power transmitted from power transmitter 13 by the electromagnetic wave. A rectifier included in wireless power receiving apparatus 11 rectifies the electromagnetic wave received by power receiver 15 into a direct current. Wireless power transmission apparatus 10 and wireless power receiving apparatus 11 other than those of FIGS. 1(B) and 2(E) are described on the premise of a configuration in FIG. 1(A), but may have a configuration in FIG. 1(B) and to configuration in FIG. 2(E).

FIG. 1(B) is a functional block diagram of wireless power transmission apparatus 10 and wireless power receiving apparatus 11 constituting the wireless power transmission system using power transmission beam pattern 1. FIG. 1(B) is different from FIG. 1(A) in that wireless power transmission apparatus 10 has a power supply 14 and wireless power receiving apparatus 11 has a battery 17. Power supply 14 is a power supply circuit for forming power transmission beam pattern 1 and supplying power to power receiver 15. Power supply 14 is connected to power transmitter 13 via beam controller 12. Power supply 14 may be external to wireless power transmission apparatus 10. Battery 17 stores the power rectified by rectifier 14. Battery 17 may be external to wireless power receiving apparatus 11.

Wireless power receiving apparatus 11 including battery 17 may be placed on a mobile object, and battery 17 may be used as motive power or electric power of the mobile object. Examples of the mobile object include a vehicle, a ship, an aircraft, a balloon, an unmanned aerial vehicle (UAV) including an unmanned aircraft for a stratospheric communication platform, and the like. Instead of wireless power receiving apparatus 11, wireless power transmission apparatus 10 may be placed on such a mobile object. An external device using battery 17 may be a sensor, a lighting fixture, or the like instead of the mobile object. As the external device, a device that is difficult to wire or a device that is difficult to replace battery 17 is also suitable. Wireless power receiving apparatus 11 may be placed on an external device other than a flight vehicle, or wireless power receiving apparatus 11 and the external device may be connected by wiring.

FIG. 2 is a configuration diagram of wireless power transmission apparatus 10 (power transmission device 10) and wireless power receiving apparatus 11 (power receiving device 11) constituting the wireless power transmission system using power transmission beam pattern 1. FIG. 2(A) illustrates a case where there are one power receiving device 11 and one power transmission device 11 as in FIGS. 1(A) and 1(B). 2(B) illustrates a case where there are one power receiving device 11 and two power transmission devices 10. There may be three or more power transmission devices 10. That is, the number of power transmission devices 10 is two or more. FIG. 2(C) illustrates a case where there are two power receiving devices 11 and one power transmission device 10. There may be three or more power receiving devices 11. That is, the number of power receiving devices 11 is two or more. FIGS. 2(D) and 2(E) illustrate a case where there are two or more of power receiving devices 11 and two or more of power transmission devices 10. FIG. 2(E) illustrates a case where power supply 14 is external to power transmission devices 10, and is a case where one power supply 14 is shared by a plurality of power transmission devices 10. In FIG. 2, when there are a plurality of power transmission devices 10, power transmission beam pattern 1 may be power transmission beam pattern 1 formed by a plurality of power transmitters 13.

In the wireless power transmission system according to the first embodiment illustrated in FIGS. 1 and 2, wireless power transmission apparatus 10 (power transmission device 10) receives the information on power transmission beam pattern 1 from outside, and wireless power transmission condition learning apparatus (wireless power transmission condition learning apparatus 2) according to the first embodiment learns and provides power transmission beam pattern 1. Wireless power transmission condition learning apparatus 2 includes a device information inputter 3, beam pattern information 4, and a learner 5.

The wireless power transmission condition learning apparatus wireless power transmission condition determining apparatus 7) according to the first embodiment determines power transmission beam pattern 1 from a new input information item (which may be acquired via an input information acquirer 6) using a learning result (learning model) learned by wireless power transmission condition learning apparatus 2. Wireless power transmission condition determining apparatus 7 includes an input information inputter 8 and a wireless power transmission condition determiner 9. Wireless power transmission apparatus 10 may include wireless power transmission condition determining apparatus 7. Wireless power transmission apparatus 10 may include wireless power transmission condition learning apparatus 2 and wireless power transmission condition determining apparatus 7. In these cases, unlike FIG. 1, wireless power transmission apparatus 10 receives internally the information of power transmission beam pattern 1 from wireless power transmission condition determining apparatus 7 (wireless power transmission condition determiner 9).

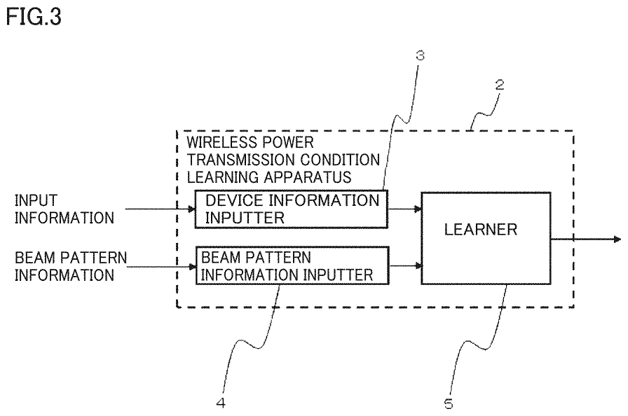

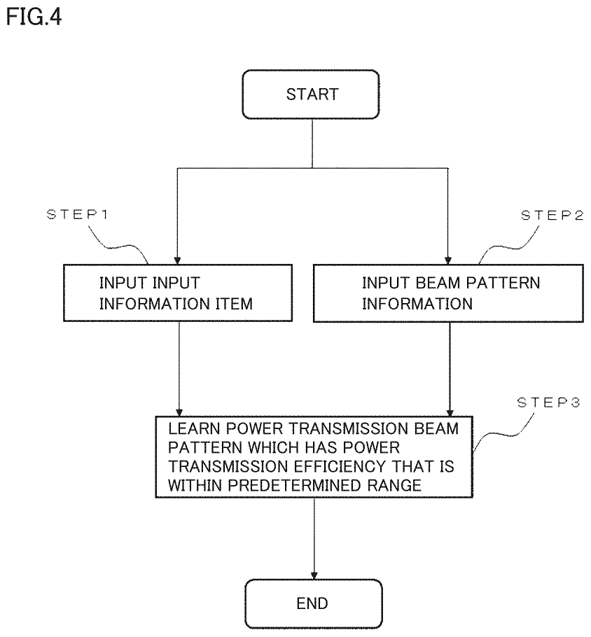

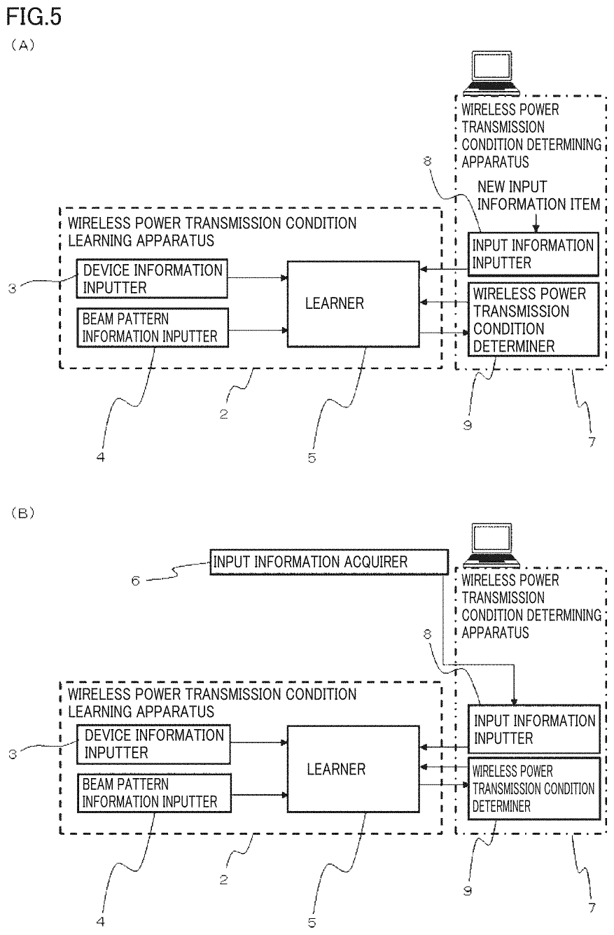

FIGS. 3 and 5 are explanatory diagrams of the wireless power transmission condition learning apparatus (wireless power transmission condition learning method). FIG. 4 is a flowchart illustrating an operation of the wireless power transmission condition learning apparatus (wireless power transmission condition learning method). FIG. 5 is also an explanatory diagram of the wireless power transmission condition determining apparatus (wireless power transmission condition determining method). FIG. 5(A) is a block diagram of the wireless power transmission condition learning apparatus and the wireless power transmission condition determining apparatus that acquires a new input information item from outside. FIG. 5(B) is a block diagram of the wireless power transmission condition learning apparatus and the wireless power transmission condition determining apparatus including input information acquirer 6 that acquires a new input information item from outside.

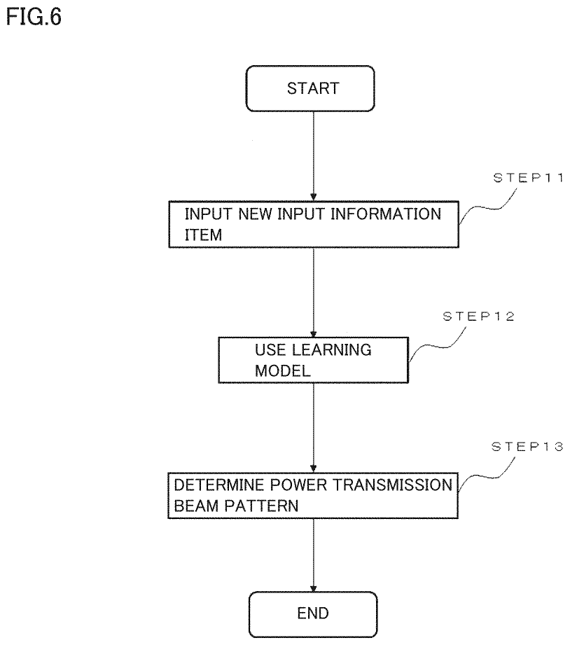

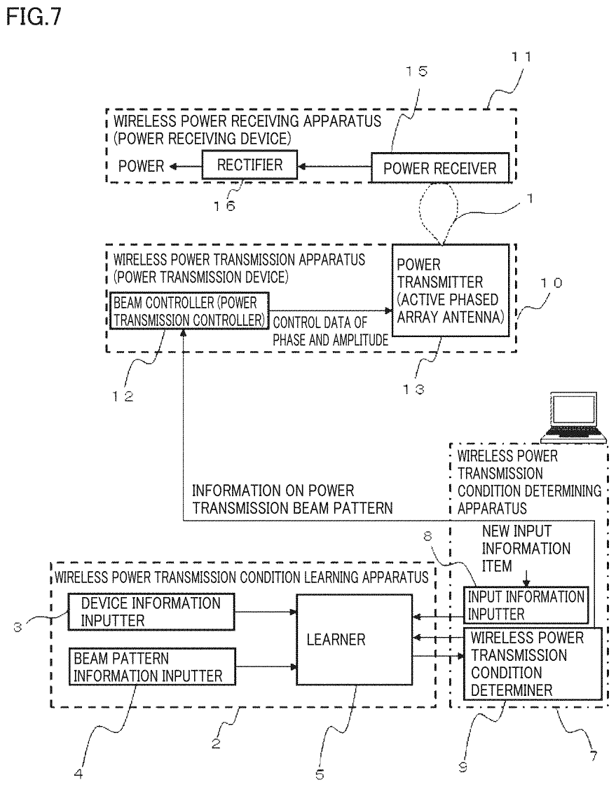

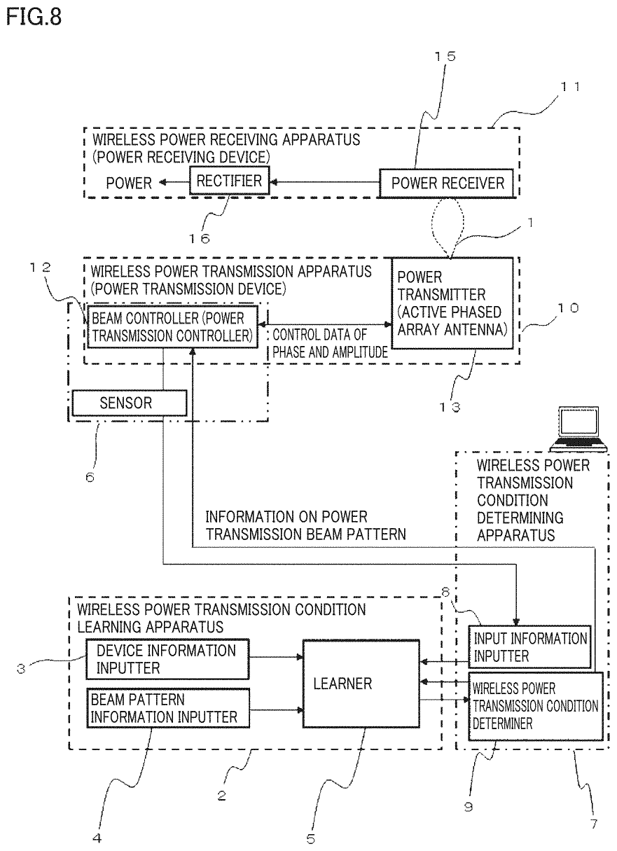

FIG. 6 is a flowchart illustrating an operation of the wireless power transmission condition determining apparatus (wireless power transmission condition determining method). FIG. 7 is a block diagram of the wireless power transmission condition learning apparatus, the wireless power transmission condition determining apparatus that acquires a new input information item from outside, the wireless power transmission apparatus, and the wireless power receiving apparatus. FIG. 8 is a block diagram of the wireless power transmission condition learning apparatus, the wireless power transmission condition determining apparatus including input information acquirer 6 that acquires a new input information item from outside, the wireless power transmission apparatus, and the wireless power receiving apparatus. In the drawings, the same reference signs denote the same or corresponding parts, and detailed description thereof is not repeated.

In FIGS. 3 and 5, the wireless power transmission condition learning apparatus (wireless power transmission condition learning apparatus 2) according to the first embodiment includes device information inputter 3, beam pattern information inputter 4, and learner 5 as described above. Wireless power transmission condition learning apparatus 2 learns power transmission beam pattern 1 for transmitting the electromagnetic wave from power transmission device 10 to power receiving device 11. Device information inputter 3 receives input of any two or more of input information items of distance information which is information on a distance between power transmission device 10 and power receiving device 11, environment information which is information on an environment of a power transmission space between power transmission device 10 and power receiving device 11, or condition information which is at least one of a device performance condition or a device setting condition of power transmission device 10 and power receiving device 11.

In FIGS. 3 and 5, beam pattern information inputter 4 receives input of beam pattern information which is information on power transmission beam pattern 1 formed by power transmission device 10 and power transmission efficiency of power transmission beam pattern 1, for each combined condition of any two or more of input information items inputted through device information inputter 3. Learner 5 learns power transmission beam pattern 1 which has the power transmission efficiency that is within a predetermined range for each combined condition of any two or more of input information items inputted through device information inputter 3 from the beam pattern information. At a stage where learning of learner 5 is shallow, it is assumed that the power transmission efficiency does not reach the predetermined range. In this case, learner 5 is required only to learn power transmission beam pattern 1 having a maximum power transmission efficiency at the stage of the learning. That is, power transmission beam pattern 1 in which the power transmission efficiency in power transmission device 10 (learner 5) according to the first embodiment becomes within the predetermined range includes such a case.

Device information inputter 3 and beam pattern information inputter 4 may be 11 any combination including power transmission device 10 and power receiving device 11 illustrated in FIGS. 1 and 2. The distance information which is the information on the distance between power transmission device 10 and power receiving device 11 may be information on a positional relationship considering that at least one of power transmission device 10 or power receiving device 11 is placed on the mobile object. That is, one or more power transmission devices 10 and one or more power receiving devices 11 are sufficient. For example, in the case of FIG. 2(B), device information inputter 3 receives input of the information on the positional relationship between power receiving device 11 and two or more of power transmission devices 10 as the distance information, and beam pattern information inputter 4 receives, as the beam pattern information, input of information including the information on power transmission beam pattern 1 formed by two or more of power transmission devices 10. That is, beam pattern information inputter 4 also receives input of information on individual power transmission beam pattern 1 for each power transmission device 10.

Subsequently, in the case of FIG. 2(C), device information inputter 3 receives input of the information on the positional relationship between two or more of power receiving devices 11 and power transmission device 10 as the distance information, and beam pattern information inputter 4 receives, as the beam pattern information, input of the information including the information on power transmission beam pattern 1 formed for each of two or more of power receiving devices 11. That is, beam pattern information inputter 4 also receives input of the information on power transmission beam pattern 1 for transmitting power to at least one of two or more of power receiving devices 11 in one power transmission beam pattern 1.

In the case of FIGS. 2(D) or 2(E) device information inputter 3 receives input of the information on the positional relationship between two or more of power receiving devices 11 and two or more of power transmission devices 10 as the distance information, and beam pattern information inputter 4 receives, as the beam pattern information, input of information including the information on power transmission beam pattern 1 formed by two or more of power transmission devices 10 or the information on power transmission beam pattern 1 formed for each of two or more of power receiving devices 11. That is, beam pattern information inputter 4 also receives input of information on individual power transmission beam pattern 1 for each power transmission device 10. In addition, beam pattern information inputter 4 also receives input of the information on power transmission beam pattern 1 for transmitting power to at least one of two or more of power receiving devices 11 in one power transmission beam pattern 1.

The distance information which is the information on the distance between power transmission device 10 and power receiving device 11 may be information on a positional relationship changing over time considering that at least one of power transmission device 10 or power receiving device 11 is placed on the mobile object. That is, the information on the positional relationship inputted through device information inputter 3 varies with a lapse of time, and beam pattern information inputter 4 receives input of the information including the information on power transmission beam pattern 1 as the beam pattern information for each of the information on the positional relationship, the information on the positional relationship varying with a lapse of time.

It is conceivable that device information inputter 3 receives preferably input of information on a priority order of power transmission far each power receiving device 11 as a device information performance condition, and beam pattern information inputter 4 receives preferably input of information including the information on power transmission beam pattern 1 formed in accordance with the priority order of power transmission for each power receiving device 11. In this case, it is conceivable that the information on the priority order inputted through device information inputter 3 is a remaining amount of battery 17 included in power receiving device 11 or a remaining amount of battery 17 of a device connected to power receiving device 11.

It is conceivable that device information inputter 3 receives input of information on an amount of power that is transmittable by power transmission device 10 as the device information performance condition. In this case, it is conceivable that device information inputter 3 receives input of the information on the amount of power transmittable by power transmission device 10, the information being a capacity (remaining amount) of power supply 14 of power transmission device 10 or a capacity (remaining amount) of power supply 14 of the device connected to power transmission device 11.

In addition to the device information performance condition, as described above, device information inputter 3 may receive input of the information on the positional relationship between power receiving device 11 and power transmission device 10 as the distance information. Similarly, in consideration of the mobile object, the information on the positional relationship inputted through device information inputter 3 varies with a lapse of time, and beam pattern information inputter 4 may receive input of the information including the information on power transmission beam pattern 1 as the beam pattern information for each of the information on the positional relationship, the information on the positional relationship varying with a lapse of time.

Device information inputter 3 receives preferably input of output information of power transmission device 10 as a device information setting condition. In this case, for example, beam pattern information inputter 4 is required only to receive input of information including the information on power transmission beam pattern 1 when the output information of power transmission device 10 is maximum.

In any of the above cases, the information on the positional relationship inputted through device information inputter 3 varies with a lapse of time, in which the information may include variation caused by at least one of deformation of an array antenna (power transmitter 13) included in power transmission device 11 or tilt or deformation of an antenna (power receiver 15) included in power receiving device 11. That is, it can be understood that the information on the positional relationship inputted through device information inputter 3 and varying with a lapse of time includes variation in a relative distance between power transmission device 10 and power receiving apparatus 11.

The information on the positional relationship inputted through device information inputter 3 may be acquired by any of a laser tracker, a satellite positioning system, a camera image, or light detection and ranging (LiDAR). The information on the positional relationship inputted through device information inputter 3 may be acquired by at least one of an amplitude monopulse or a rotating element electric field vector method for forming power transmission beam pattern 1 by the array antenna (power transmitter 13) included in power transmission device 10.

For example, in a rotating electric field vector method, power transmission device 10 receives a pilot signal transmitted from a pilot signal transmission antenna formed near power receiver 15 included in power receiving device 11, phase control based on a command signal is performed by beam controller 12, and thus the positional relationship between power transmission device 10 and power receiving device 11 can be obtained. Power transmission device 10 receives the pilot signal through a pilot signal reception antenna, performs phase control on a phase shifter such that the radiated electromagnetic wave (power transmission beam pattern 1) is directed in an arrival direction of the pilot signal received by a tracking receiver, and reproduces the command signal superimposed on the pilot signal by a demodulator. Details are disclosed in PTL 2 and Japanese Patent Laid-Open No. 2001-201526.

Not only the positional relationship inputted through device information inputter 3 but also information on at least one of the amplitude monopulse or the rotating element electric field vector method for forming power transmission beam pattern 1 by the array antenna (power transmitter 13) included in power transmission device 10 may be inputted through device information inputter 3 as the device information setting condition.

Similarly, not only the positional relationship inputted through device information inputter 3 but also information on the deformation of the array antenna (Power transmitter 13) included in power transmission device 10 may be inputted through device information inputter 3 as the device information performance condition. In this case, for example, the information on the deformation of the array antenna (power transmitter 13) included in power transmission device 10 inputted through device information inputter 3 varies with a lapse of time, and beam pattern information inputter 4 may receive input of the information including the information on power transmission beam pattern 1 as the beam pattern information for each of the information on the deformation of the array antenna (power transmitter 13) included in power transmission device 10, the information on the deformation varying with a lapse of time.

Similarly, not only the positional relationship inputted through device information inputter 3 but also information on the tilt or the deformation of the antenna (power receiver 15) included in power receiving device 11 may be inputted through device information inputter 3 as the device information performance condition. In this case, for example, the information on the tilt or the deformation of the antenna (power receiver 15) included in power receiving device 11 inputted through device information inputter 3 varies with a lapse of time, and beam pattern information inputter 4 may receive input of the information including the information on power transmission beam pattern 1 as the beam pattern information for each of the information on the tilt or the deformation of the antenna (power receiver 15) included in power receiving device 11, the information on the tilt or the delimitation varying with a lapse of time.

Preferably, device information inputter 3 may receive, as the environment information, input of information on any of a temperature, humidity, wind direction, wind speed, solar radiation value, weather information, atmospheric pressure, or radio wave environment in the power transmission space between power transmission device 10 and power receiving device 11, or an obstacle existing in the power transmission space. Beam pattern information inputter 4 may receive input of information on a direction of power transmission beam pattern 1 to be formed as the beam pattern information.

Referring to FIG. 4, description is made of the operation of the wireless power transmission condition learning apparatus according to the first embodiment (wireless power transmission condition learning method according to the first embodiment). In FIG. 4, step 1 is a processing step in which device information inputter 3 receives input of any two or more of input information items of the distance information which is the information on the distance between power transmission device 10 and power receiving device 11, the environment information which is information on the environment of the power transmission space between power transmission device 10 and power receiving device 11, or the condition information which is at least one of the device performance condition or the device setting condition of power transmission device 10 and power receiving device 11. Step 2 is a processing step in which beam pattern information inputter 4 receives input of the beam pattern information which is the information on power transmission beam pattern 1 formed by power transmission device 10 and the power transmission efficiency of power transmission beam pattern 1, for each combined condition of any two or more of input information items inputted through device information inputter 3. The order of processing of steps 1 and 2 is not limited. The processing may be performed at the same time.

in FIG. 4, step 3 is a processing step of causing learner 5 to learn power transmission beam pattern 1 in which the power transmission efficiency becomes within a predetermined range for each combined condition of any two or more of input information items inputted through device information inputter 3 from the beam pattern information on the basis of the input information items inputted through device information inputter 3 and the beam pattern information inputted through beam pattern information inputter 4. As described above, it is sufficient to apply machine learning such as AI to learner 5 (wireless power transmission condition learning apparatus 2). Learner 5 (wireless power transmission condition learning apparatus 2) constructs and accumulates a learning model. Other operations of learner 5, input information items, and beam pattern information are similar to those described in the wireless power transmission condition learning apparatus (wireless power transmission condition learning apparatus 2) according to the first embodiment.

In FIGS. 5(A) and 5(B), the wireless power transmission condition determining apparatus (wireless power transmission condition determining apparatus 7) according to the first embodiment uses the learning result (learning model) of wireless power transmission condition learning apparatus 2 illustrated in FIGS. 3 and 5. As described above, wireless power transmission condition determining apparatus 7 includes input information inputter 8 and wireless power transmission condition determiner 9. Input information inputter 8 receives input of new input information items. The new input information items are any two or more of input information items of the distance information which is the information on the distance between power transmission device 10 and power receiving device 11 which are to construct a new wireless power transmission system, the environment information which is information on the environment of the power transmission space between power transmission device 10 and power receiving, device 11, or the condition information which is at least one of the device performance condition or the device setting condition of power transmission device 10 and power receiving device 11.

Wireless power transmission condition determiner 9 determines power transmission beam pattern 1 which has the power transmission efficiency that is within a predetermined range using the new input information item inputted through input information inputter 8 on the basis of the learning result (learning model) learned by learner 5. Power transmission beam pattern 1 having been determined is outputted as the information on power transmission beam pattern 1. As described above, at a stage where learning of learner 5 is shallow, it is assumed that the power transmission efficiency does not reach the predetermined range. In this case, learn learns power transmission beam pattern 1 having the maximum power transmission efficiency at the stage of the learning. Thus, on the basis of the learning, wireless power transmission condition determiner 9 determines the information on power transmission beam pattern 1. That is, power transmission beam pattern 1 in which the power transmission efficiency determined by power transmission device 10 (wireless power transmission condition determiner 9) according to the first embodiment becomes within the predetermined range includes such a case.

The wireless power transmission condition determining apparatus (wireless power transmission condition determining apparatus 7) according to the first embodiment may further include input information acquirer 6 illustrated in FIG. 5(B) for acquiring a new input information item. FIG. 5(A) illustrates wireless power transmission condition determining apparatus 7 without input information acquirer 6. FIG. 8 described later illustrates a case where there is input information acquirer 6, and FIG. 7 illustrates a case where there is no input information acquirer 6. When the new input information item is environment information and is any of the temperature, the humidity, wind direction, wind speed, solar radiation value, weather information, atmospheric pressure, or radio wave environment in the power transmission space between power transmission device 10 and power receiving device 11, or the obstacle existing in the power transmission space, input information acquirer 6 is required to be a sensor 6 that can acquire the new input information item from the power transmission space. Sensor 6 is, for example, an environment sensor 6, a positioning sensor 6, or a camera 6. Sensor 6 may be a laser tracker 6, a satellite positioning system 6, or a LiDAR 6. When the new input information items (distance information and condition information) are the deformation of the array antenna (power transmitter 13) included in power transmission device 11 and the tilt or the deformation of the antenna (power receiver 15) included in power receiving device 11, sensor 6 may be a sensor that observe power transmission device 10 or power receiving device 11.

When sensor 6 is environment sensor 6, sensor 6 is required only to be a sensor that can acquire an input information which is at least one of the temperature, humidity, wind direction, a wind speed, a solar radiation value, weather information, an atmospheric pressure, a radio wave environment, or an obstacle existing in the power transmission space. When the input information item is the temperature or humidity, to thermohygrometer is suitable for environment sensor 10. When the input information item is the wind speed or wind direction, a LiDAR device using a light wave or a sonar device using a sound wave is suitable for environment sensor 10. When the input information item is the solar radiation value, a solar radiation value meter (solar radiation meter) is suitable for environment sensor 6. When the input information item is the weather information, a weather radar using radio waves is suitable for environment sensor 6. When the wind speed, wind direction, solar radiation value, temperature, humidity, and weather information are obtained from a forecast, the information from environment sensor 6 is obtained via a network. In order to obtain the input information item, environment sensor 6 may be disposed in the power transmission space or environment sensor 6 may be provided in power transmission device 10 or power receiving device 11, if necessary. There may plurality of environment sensors 6 including different functions.

When the new input information item (distance information and condition information) is at least one of the amplitude monopulse or the rotating element electric field vector method for forming power transmission beam pattern 1 by the array antenna (power transmitter 13) included in power transmission device 10, beam controller 12 corresponds to input information acquirer 6. This case is described in the description of the wireless power transmission apparatus and the wireless power receiving apparatus according to the first embodiment with reference to FIG. 8.

Referring to FIG. 6, description is made of the operation of the wireless power transmission condition determining apparatus according to the first embodiment (wireless power transmission condition determining method according to the first embodiment). In FIG. 6, step 11 is a processing step in which input information inputter 8 receives input of new input information item. Step 12 is a processing step in which wireless power transmission condition determiner 9 uses the learning result (learning model) of learner 5. Step 13 is a processing step in which wireless power transmission condition determiner 9 determines power transmission beam pattern 1 in which the power transmission efficiency becomes within a predetermined range using the new input information item inputted through input information inputter 8 on the basis of the learning result learned by learner 5. Other details of the new input information item and the operations of input information inputter 8 and wireless power transmission condition determiner 9 are similar to those described in the wireless power transmission condition learning apparatus (wireless power transmission condition learning apparatus 2) according to the first embodiment. The same applies to a case where input information acquirer 6 (sensor 6 and beam controller 12) is added.

In FIGS. 7 and 8, the operations of the wireless power transmission apparatus and the wireless power receiving apparatus according to the first embodiment are wireless power transmission apparatus 10 and wireless power receiving apparatus 11 using the learning result (learning model) of wireless power transmission condition learning apparatus 2 illustrated in FIGS. 3 and 5 and the power transmission beam pattern determined by wireless power transmission condition determining apparatus 7. FIG. 7 illustrates wireless power transmission apparatus 10 and wireless power receiving apparatus 11 using wireless power transmission condition determining apparatus 7 without independent input information acquirer 6 in the wireless power transmission system. FIG. 8 illustrates wireless power transmission apparatus 10 and wireless power receiving apparatus 11 using wireless power transmission condition determining apparatus 7 with independent input information acquirer 6 in the wireless power transmission system. FIG. 8 illustrates a case where input information acquirer 6 includes beam controller 12 and sensor 6 formed around wireless power transmission apparatus 10. The new input information item inputted through wireless power transmission condition determining apparatus 7 illustrated in FIG. 7 may be obtained from input information acquirer 6 provided outside the wireless power transmission system of wireless power transmission condition determining apparatus 7.

The wireless power transmission apparatus according to the first embodiment may be wireless power transmission apparatus 10 including wireless power transmission condition determining apparatus 7. In this case, the power transmission apparatus includes beam controller 12 that generates information on the phase and the amplitude of the electromagnetic wave for thrilling power transmission beam pattern 1 determined by wireless power transmission condition determiner 9, and power transmitter 13 that forms power transmission beam pattern 1 from the information on the phase and the amplitude of the electromagnetic wave generated by beam controller 12.

The wireless power transmission apparatus according to the first embodiment may be wireless power transmission apparatus 10 that transmits power in power transmission beam pattern 1 determined by wireless power transmission condition determining apparatus 7. In this case, the power transmission apparatus includes beam controller 12 that generates information on the phase and the amplitude of the electromagnetic wave for forming power transmission beam pattern 1 for transmitting power, and power transmitter 13 that forms power transmission beam pattern 1 from the information on the phase and the amplitude of the electromagnetic wave generated by beam controller 12.

A device that receives the electromagnetic wave transmitted from wireless power transmission apparatus 10 is the wireless power receiving apparatus according to the first embodiment. That is, wireless power receiving apparatus 11 receives power transmitted in power transmission beam pattern 1 formed by wireless power transmission apparatus 10. Wireless power receiving apparatus 11 includes power receiver 15 that receives power in power transmission beam pattern and a rectifier 16 that rectifies the power received by power receiver 15.

In the wireless power transmission apparatus and the wireless power receiving apparatus according to the first embodiment, when the new input information item changes with a lapse of time, the new input information item is required to be inputted sequentially through wireless power transmission condition determining apparatus 7 (input information inputter 8) according to the first embodiment every time the new input information item changes. When the change of the new input information item with a lapse of time can be estimated in advance, the new input information item may be inputted through input information inputter 8 together with time information in advance.

It is therefore preferable to input, to the wireless power transmission condition learning apparatus (device information inputter 3) according to the first embodiment, the input information item estimated to be changed with a lapse of time together with the time information in advance. However, as the learning of learner 5 progresses, that is, a large number of input information items are inputted, it goes without saying that wireless power transmission apparatus 10 and wireless power receiving apparatus 11 can cope with the new input information item that changes with a lapse of time without inputting the input information item and the time information together to device information inputter 3. The input information item with the time information and the input information item without the time information may be used to cause learner 5 to learn.

As described above, the wireless power transmission apparatus and the wireless power receiving apparatus according to the first embodiment can obtain power transmission beam pattern 1 which has the power transmission efficiency that is within a predetermined range as long as receiving input of any two or more of input information items of the distance information which is the information on the distance between power transmission device 10 and power receiving device 11, the environment information which is the information on the environment of the power transmission space between power transmission device 10 and power receiving device 11, or the condition information which is at least one of the device performance condition or the device setting condition of power transmission device 10 and power receiving device 11.

In the wireless power transmission apparatus and the wireless power receiving apparatus according to the first embodiment, even in a case where it is difficult to obtain experimentally power transmission beam pattern 1 suitable for power transmission device 10 and power receiving device 11, or in a case where the positional relationship between power transmission device 10 and power receiving device 11 varies greatly, learner 5 whose degree of learning has been improved to be high level in advance can obtain suitable power transmission beam pattern 1. Even in a complex situation as illustrated in FIG. 2, the wireless power transmission apparatus and the wireless power receiving apparatus according to the first embodiment can easily form suitable power transmission beam pattern 1 including power transmission beam pattern 1 formed by the plurality of power transmitters 13 by switching temporally power transmission beam pattern 1 as necessary.

### REFERENCE SIGNS LIST

1: power transmission beam pattern, 2: wireless power transmission condition learning apparatus, 3: device information inputter, 4: beam pattern information inputter, 5: learner, 6: input information acquirer (sensor), 7: wireless power transmission condition determining apparatus, 8: input information inputter, 9: wireless power transmission condition determiner, 10: wireless power transmission apparatus (power transmission device), 11: wireless power receiving apparatus (power receiving device), 12: beam controller (power transmission controller), 13: power transmitter (active phased array antenna, power transmission antenna), 14: power supply, 15: power receiver (power receiving antenna), 16: rectifier, 17: battery

1. A wireless power transmission condition learning apparatus to learn a power transmission beam pattern formed to transmit an electromagnetic wave from a power transmission device to a power receiving device, the wireless power transmission condition learning apparatus comprising:
a device information inputter to receive input of any two or more of input information items including distance information, environment information, or condition information, the distance information being information on a distance between the power transmission device and the power receiving device, the environment information being information on an environment of a power transmission space between the power transmission device and the power receiving device, the condition information being at least one of a device performance condition or a device setting condition of the power transmission device and the power receiving device;
a beam pattern information inputter to receive input of beam pattern information, the beam pattern information being information on the power transmission beam pattern formed by the power transmission device and a power transmission efficiency of the power transmission beam pattern and being inputted for each combined condition of any two or more of the input information items inputted through the device information inputter; and
a learner to learn the power transmission beam pattern from the beam pattern information for the each combined condition, the power transmission beam pattern having the power transmission efficiency being within a predetermined range for the each combined condition.

2. The wireless power transmission condition learning apparatus according to claim 1, wherein
the device information inputter receives, as the distance information, input of information on a positional relationship between the power receiving device and two or more of the power transmission devices, and
the beam pattern information inputter receives, as the beam pattern information, input of information including information on the power transmission beam pattern formed by the two or more of the power transmission devices.

3. The wireless power transmission condition learning apparatus according to claim 1, wherein
the device information inputter receives, as the distance information, input of information on a positional relationship between two or more of the power receiving devices and the power transmission device, and
the beam pattern information inputter receives, as the beam pattern information, input of information including information on the power transmission beam pattern formed for each of the two or more of the power receiving devices.

4. The wireless power transmission condition learning apparatus according to claim 1, wherein
the device information inputter receives, as the distance information, input of information on a positional relationship between two or more of the power receiving devices and two or more of the power transmission devices, and
the beam pattern information inputter receives, as the beam pattern information, input of information including at least one of information on the power transmission beam pattern formed by the two or more of the power transmission devices or information on the power transmission beam pattern formed for each of the two or more of the power receiving devices.

5. The wireless power transmission condition learning apparatus according to claim 3, wherein
the device information inputter receives, as the device performance condition, input of information on a priority order of power transmission for each of the power receiving devices, and
the beam pattern information inputter receives input of information including the information on the power transmission beam pattern formed in accordance with the priority order.

6. The wireless power transmission condition learning apparatus according to claim 3, wherein the device information inputter receives, as the device performance condition, input of the information on a priority order of power transmission for each of the power receiving devices, the information on the priority order being a remaining battery amount of the power receiving device or a remaining battery amount of a device connected to the power receiving device.

7. The wireless power transmission condition learning apparatus according to claim 5, wherein the device information inputter receives, as the device performance condition, input of information on an amount of power being transmittable by the power transmission device.

8. The wireless power transmission condition learning apparatus according to claim 7, wherein the device information inputter receives input of the information on the amount of power, the information on the amount of power being a power supply capacity of the power transmission device or a power supply capacity of a device connected to the power transmission device.

9. The wireless power transmission condition learning apparatus according to claim 8, wherein the device information inputter receives, as the distance information, input of information on the positional relationship between the power receiving device and the power transmission device.

10. The wireless power transmission condition learning apparatus according to claim 9, wherein
the device information inputter receives input of the information on the positional relationship that varies with a lapse of time, and
the beam pattern information inputter receives, as the beam pattern information, input of information including the information on the power transmission beam pattern for each of the information on the positional relationship varying with the lapse of time.

11. The wireless power transmission condition learning apparatus according to claim 10, wherein the information on the positional relationship inputted through the device information inputter and varying with the lapse of time includes variation caused by at least one of deformation of an array antenna of the power transmission device or tilt or deformation of an antenna of the power receiving device.

12. The wireless power transmission condition learning apparatus according to claim 10, wherein the information on the positional relationship inputted through the device information inputter and varying with the lapse of time includes variation in a relative distance between the power transmission device and the power receiving device.

13. The wireless power transmission condition learning apparatus according to claim 9, wherein the information on the positional relationship inputted through the device information inputter is at least one of information acquired by any of a laser tracker, a satellite positioning system, a camera image, or a LiDAR, or information acquired by at least one of an amplitude monopulse or a rotating element electric field vector method for forming the power transmission beam pattern by the array antenna of the power transmission device.

14. The wireless power transmission condition learning apparatus according to claim 1, wherein the device information inputter receives, as the device setting condition, input of output information of the power transmission device.

15. The wireless power transmission condition learning apparatus according to claim 14, wherein the beam pattern information inputter receives input of information including information on the power transmission beam pattern when the output information is maximum.

16. The wireless power transmission condition learning apparatus according to claim 1, wherein the device information inputter receives, as the device setting condition, input of information on at least one of the amplitude monopulse or the rotating element electric field vector method for forming the power transmission beam pattern by the array antenna of the power transmission device.

17. The wireless power transmission condition learning apparatus according to claim 1, wherein the device information inputter receives, as the device performance condition, input of information on the deformation of the array antenna of the power transmission device.

18. The wireless power transmission condition learning apparatus according to claim 17, wherein
the device information inputter receives input of the information on the deformation of the array antenna of the power transmission device, the information varying with a lapse of time, and
the beam pattern information inputter receives, as the beam pattern information, input of information including the information on the power transmission beam pattern for each of the information on the deformation of the array antenna of the power transmission device, the information on the deformation varying with the lapse of time.

19. The wireless power transmission condition learning apparatus according to claim 1, wherein the device information inputter receives, as the device performance condition, input of information on the tilt or the deformation of the antenna of the power receiving device.

20. The wireless power transmission condition learning apparatus according to claim 19, wherein
the device information inputter receives input of the information on the tilt or the deformation of the antenna of the power receiving device, the information varying with a lapse of time, and
the beam pattern information inputter receives, as the beam pattern information, input of information including the information on the power transmission beam pattern for each of the information on the tilt or the deformation of the antenna of the power receiving device, the information on the tilt or the deformation varying with the lapse of time.

21. The wireless power transmission condition learning apparatus according to claim 1, wherein the device information inputter receives, as the environment information, input of information on any of a temperature, humidity, wind direction, wind speed, solar radiation value, weather information, atmospheric pressure, or radio wave environment in the power transmission space, or an obstacle existing in the power transmission space.

22. The wireless power transmission condition learning apparatus according to claim 1, wherein the beam pattern information inputter receives, as the beam pattern information, input of information on a direction of the power transmission beam pattern to be formed.

23. A wireless power transmission condition determining apparatus using a learning result of the wireless power transmission condition learning apparatus according to claim 1, the wireless power transmission condition determining apparatus comprising:
an input information inputter to receive input of a new input information item of the input information items; and
a wireless power transmission condition determiner to determine the power transmission beam pattern having the power transmission efficiency being within a predetermined range using the new input information item inputted through the input information inputter based on the learning result learned by the learner.

24. A wireless power transmission apparatus comprising:
the wireless power transmission condition determining apparatus according to claim 23;
a beam controller to generate information on a phase and an amplitude of an electromagnetic wave forming the power transmission beam pattern determined by the wireless power transmission condition determiner; and
a power transmitter to form the power transmission beam pattern from the information on the phase and the amplitude of the electromagnetic wave generated by the beam controller.

25. A wireless power transmission apparatus to transmit power in the power transmission beam pattern determined by the wireless power transmission condition determining apparatus according to claim 23, the wireless power transmission apparatus comprising:
a beam controller to generate information on a phase and an amplitude of an electromagnetic wave forming the power transmission beam pattern for transmitting power; and
a power transmitter to form the power transmission beam pattern from the information on the phase and the amplitude of the electromagnetic wave generated by the beam controller.

26. A wireless power receiving apparatus to receive power transmitted in the power transmission beam pattern formed by the wireless power transmission apparatus according to claim 24, the wireless power receiving apparatus comprising:
a power receiver to receive the power in the power transmission beam pattern; and
a rectifier to rectify the power received by the power receiver.
